(19) United States
(12) Patent Application Publication
(10) Pub. No.: US 2015/0005402 A1
(43) Pub. Date: Jan. 1, 2015

(54) METHOD FOR PRODUCING EXPANDABLE STYRENE POLYMERS CONTAINING PARTICULATE ADDITIVES

(71) Applicant: BASF SE, Ludwigshafen (DE)

(72) Inventors: Patrick Spies, Neustadt (DE); Pascal Hesse, Mannheim (DE); Bernhard Schmied, Frankenthal (DE); Libor Seda, Mannheim (DE); Rainer Ostermann, Ludwigshafen (DE); Frank Braun, Ludwigshafen (DE); Gregor Haverkemper, Ludwigshafen (DE); Uwe-Johannes Lehnen, Bohl-Iggelheim (DE); Klaus Hahn, Kirchheim (DE); Jan Holoch, Leimen (DE)

(21) Appl. No.: 14/367,246

(22) PCT Filed: Dec. 17, 2012
(86) PCT No.: PCT/EP2012/075730

§ 371 Date: Jun. 20, 2014

(30) Foreign Application Priority Data
Dec. 21, 2011 (EP) 11194873.3

(51) Int. Cl. C08J 9/20; C08J 9/00

(52) U.S. Cl. CPC C08J 9/20; C08J 9/0066; C08J 2325/06
USPC 521/60; 521/56

(57) ABSTRACT

a) Production of prepolymer beads through a first suspension polymerization reaction using an aqueous suspension comprising styrene monomers and comprising particulate additives,
b) isolation of the prepolymer beads,
c) optional division of the prepolymer beads into fractions of different particle size and selection of one or more fractions for subsequent stages,
d) production of an aqueous suspension of the prepolymer beads and conduct of a second suspension polymerization reaction in the presence of blowing agent and with addition of further monomers.

The present invention relates to a process for producing expandable styrene polymers comprising particulate additives through at least two-stage polymerization in suspension, and also to prepolymer beads obtainable from the first stage.

Suspension polymerization is widely used to produce expandable polystyrene (EPS). The suspension can be stabilized by way of example by using protective colloids, such as polyvinylpyrrolidone, or what are known as Pickering stabilizers, such as magnesium pyrophosphate, as described in EP-A 575 872. Bead size and bead size distribution can be controlled by way of the amount of the stabilizer and the manner of addition of the same.

Addition of graphite as infrared absorber gives expandable styrene polymers which can be processed to give thermal-insulation materials with improved thermal insulation at low densities (U.S. Pat. No. 6,130,265). Thermal conductivity here is reduced markedly by reducing the amount of infrared. Similar improvements can be achieved with other IR absorbers, such as carbon black, silicates, and aluminum.

Polymerization in the presence of surfactant additives, such as particulate IR absorbers, or flame retardants, is often problematic because said additives can destabilize the suspension and cause coagulation. WO 99/16817 and WO 03/033579 therefore propose, for suspension polymerization in the presence of graphite particles, the use of specified peroxide initiators, such as tert-butyl 2-ethylperoxyhexanoate, which do not form any benzoyl or benzyl radicals, and the use of different peroxides with different decomposition temperatures.

DE 198 28 250 A1 describes polystyrene foam beads with a coarse-cell core and a fine cell periphery. They are produced by dissolving, in styrene, from 5 to 25% by weight of a polystyrene which comprises from 1 to 10% by weight of homogeneously dispersed graphite, and dispersing the solution in water with addition of blowing agent, and then polymerizing the mixture. The expandable polystyrene beads obtainable by this process have relatively broad bead size distribution.

The EPS beads obtained via suspension polymerization, in particular in the presence of graphite, generally exhibit a broad particle size distribution and major variations of average particle sizes between various production batches. This has necessitated subsequent sieving in order to obtain products with marketable particle sizes. The sieve fractions required are usually in the range from 0.5 to 2.0 mm.

WO 00/61648 describes a multistage seed polymerization process for producing polymer particles with average particle size at least 50 μm, by using diffusion to insert an initiator into the seed and thus activating the same.

Processes for producing expandable polystyrene comprising carbon black or comprising graphite via seed polymerization are known by way of example from WO 2010/06631, US 2009/0030096 A1, or JP-A 62-13442. Here, minipellets obtained via mixing to incorporate graphite into a polystyrene melt and extrusion and pelletization are used as seed in a subsequent suspension polymerization reaction. However, the particle size of the seed is subject to restriction imposed by the minimum diameter of the pelletizing die. Furthermore, heat-sensitive additives, such as flame retardants, e.g. HBCD, or peroxides, e.g. dicumyl peroxide, cannot be incorporated into the seed without at least some decomposition. The extrusion of pellets with high graphite content is moreover problematic because of high melt viscosities and blockage of the pelletizing die.

It was an object of the present invention to provide a simple and cost-effective process which can produce expandable styrene polymers comprising particulate additives, in particular comprising graphite, and which does not have the abovementioned disadvantages. In particular, the intention was to find a suspension polymerization process which, during the entire polymerization time, exhibits no significant instabilities, and can also give targeted control of bead size distribution with high reproducibility even at relatively high additive contents.

The object was achieved via a process for producing expandable styrene polymers, comprising the following stages:
a) producing prepolymer beads through a first suspension polymerization reaction using an aqueous suspension comprising styrene monomers and comprising particulate additives,
b) isolating the prepolymer beads,
c) optionally dividing the prepolymer beads into fractions of different particle size and selecting one or more fractions for subsequent stages,
d) producing an aqueous suspension of the prepolymer beads and carrying out at least one second suspension polymerization reaction in the presence of blowing agent and with addition of further monomers.

The expression expandable styrene polymers means styrene polymer particles comprising blowing agents.

Styrene polymers that can be used are homopolymers or copolymers made of styrene, of styrene derivatives or of copolymerizable ethylenically unsaturated monomers. These are formed in stages a) and d) via suspension polymerization of styrene and of the appropriate copolymerizable monomers, e.g. alkylstyrenes, divinylbenzene, butanediol 1,4-dimethacrylate, para-methyl-α-methylstyrene, α-methylstyrene, or acrylonitrile, butadiene, acrylic ester, or methacrylic ester. It is particularly preferable in all of the polymerization stages to use exclusively styrene as monomer.

The suspension polymerization of styrene is known per se. It has been described in detail in Kunststoff-Handbuch, Band V, “Polystyrol” [Plastics handbook, volume V, “Polystyrene”], Carl Hanser-Verlag, 1969, pages 679 to 688. The general procedure here suspends styrene, optionally together with the abovementioned comonomers, in water, and polymerizes the material to completion in the presence of organic or inorganic suspension stabilizers. The ratio by volume of aqueous phase to organic phase is preferably from 0.5 to 1.6, in particular from 1.0 to 1.4.

### Stage a)

Particulate additives that can be used are any of the additives which do not substantially dissolve in the styrene polymers. Materials preferably used as particulate additives are IR absorbers, such as metal oxides, e.g. titanium dioxide, or carbon particles. Carbon particles that can be used are various natural or synthetic carbon blacks or graphites. It is preferable that the carbon particles comprise a proportion of at least 1% by weight, preferably at least 5% by weight, of graphitic structures. The ash content of the carbon particles is preferably from 0.005 to 15% by weight, preferably from 0.01 to 10% by weight, determined in accordance with DIN 51903. It is particularly preferable to use, as particulate additives, graphite particles with average particle size in the range from 1 to 50 μm.

The average particle size of the graphite preferably used is preferably from 1 to 50 μm, in particular from 2.5 to 12 μm, and its bulk density is preferably from 100 to 500 g/l, and its specific surface area is preferably from 5 to 20 m²/g. Natural graphite or ground synthetic graphite can be used.

The total proportion of all of the particulate additives is preferably in the range from 5 to 50 percent by weight, in particular from 10 to 30 percent by weight, based on the prepolymer beads. It is particularly preferable to use exclusively carbon particles, in particular graphite, as particulate additives.

It is particularly preferable to use, as particulate additives in stage a), from 10 to 30% by weight, based on the prepolymer beads, of graphite particles with average particle size in the range from 1 to 50 μm.

It is also possible to use, as carbon particles, silane-modified carbon particles which have been modified by way of example with from 0.01 to 1% by weight, preferably with from 0.1 to 0.5% by weight, based on the carbon particles, of silane.

The silane-modified carbon particles preferably have C₃-C₁₆-alkylsilane groups or arylsilane groups, in particular C₆-C₁₂-alkylsilane groups or phenylsilane groups, at their surface. Particularly suitable materials for modifying the carbon particles are alkyl- or arylsilanes having from 1 to 3 halogen atoms or methoxy groups on the silicon atom. It is preferable to use C₃-C₁₆-alkylsilanes, or arylsilanes, in particular octyltrichlorosilane, chloro(dodecyl)dimethylsilane, hexadecyltrimethoxysilane, or phenyltrichlorosilane.

The modification with silanes leads to hydrophobization of the surface of the carbon particles via silyl groups, thus markedly reducing the interfacial activity of the carbon particles which disrupts the suspension process. Surprisingly, the process known per se for hydrophobizing hydrophilic surfaces via silanization in the gas phase or in solvents, such as toluene, also functions in the case of relatively hydrophobic graphite, for the masking of residual polar groups. The surface-modification of the carbon particles can give better compatibility with, or indeed binding to, the polymer matrix.

Materials that can be added in stage a) in addition to the particulate additives are the usual additional substances, for example flame retardants, nucleating agents, UV stabilizers, chain-transfer agents, plasticizers, pigments, and antioxidants.

Materials that can be used for the suspension polymerization reaction, alongside the additives listed above, are in particular the usual peroxide initiators and suspension stabilizers, such as protective colloids, inorganic Pickering salts, and anionic and nonionic surfactants.

Preferred additional substances used comprise halogen-containing or halogen-free flame retardants. Organic, in particular aliphatic, cycloaliphatic, and aromatic, bromine compounds are particularly suitable, examples being hexabromocyclododecane (HBCD), pentabromomonochlorocyclohexane, pentabromophenyl allyl ether, or brominated styrene polymers, such as styrene-butadiene block copolymers, where these can be used alone or in the form of mixtures. It is preferable that flame retardants used comprise exclusively brominated styrene polymers or brominated styrene-butadiene block copolymers.

The average molecular weight of the halogenated polymer used as flame retardant is preferably in the range from 5000 to 300000, in particular from 30000 to 150000, determined by means of gel permeation chromatography (GPC) in tetrahydrofuran against polystyrene standard.

The weight loss of the halogenated polymer in thermogravimetric analysis (TGA) is 5% by weight at a temperature of 250° C. or above, preferably in the range from 270 to 370° C.

Halogenated polymers preferred as flame retardants are brominated polystyrene and styrene-butadiene block copolymer having bromine content in the range from 40 to 80% by weight.

The effect of the bromine-containing flame retardants can be improved via addition of C—C— or O—O-labile organic compounds. Examples of suitable flame retardant synergists are dicumyl and dicumyl peroxide. A preferred combination is composed of from 0.6 to 5% by weight of organic bromine compound and from 0.1 to 1.0% by weight of the C—C— or O—O-labile organic compound.

From 0.1 to 10% of white oil or Hexamoll Dinch is generally used as plasticizer in stage a) in order to improve the expandability of the final product.

Amounts of from 0.3 to 5% by weight, based on water, of a phosphate, preferably magnesium pyrophosphate or tricalcium phosphate, can be used in order to stabilize the aqueous suspension. It is particularly preferable to use magnesium pyrophosphate.

Magnesium sulfate heptahydrate is added in addition to magnesium pyrophosphate in order to stabilize the aqueous suspension in stage a) in particular when high proportions of a particulate additive are used. Preference is given to an addition of from 0.05 to 1% by weight of magnesium sulfate heptahydrate, based on water. It is also particularly preferable that the addition of magnesium sulfate heptahydrate is in the range from 0.1 to 0.5% by weight, based on the organic phase. The organic phase is composed of the monomers and optionally styrene polymers and of additives not soluble in water.

The magnesium pyrophosphate is preferably produced immediately prior to the polymerization reaction via combination of maximum-concentration solutions of pyrophosphate and magnesium ions, where the amount used of a magnesium salt is that stoichiometrically required for precipitation of Mg₂P₂O₇. The magnesium salt can be present in solid form or in aqueous solution. In one preferred embodiment, the magnesium pyrophosphate is produced via combination of aqueous solutions of sodium pyrophosphate (Na₄P₂O₇) and magnesium sulfate (MgSO₄ 7H₂O). The amount added of the magnesium salt is at least that required stoichiometrically, and is preferably the stoichiometric amount. It is advantageous for the process of the invention to avoid the presence of any excess of alkali metal pyrophosphate.

In the process of the invention it is preferable to use emulsifiers comprising sulfonate groups, known as extenders. Among said extenders are by way of example sodium dodecylbenzenesulfonate, long-chain alkylsulfonates, vinylsulfonate, and diisobutylnaphthalenesulfonate. Extenders used are preferably alkali metal salts of dodecylbenzenesulfonic acid and/or alkali metal salts of a mixture of C₁₂-C₁₇-alkylsulfonic acids. One particularly suitable mixture of C₁₂-C₁₇-alkylsulfonates is composed of predominantly secondary sodium alkylsulfonates having average chain length C₁₅. A mixture of this type is marketed as E30 by Leuna Tenside GmbH. The extenders make it easier to stabilize the suspension in the presence of sparingly soluble inorganic compounds.

The amounts generally used of the extenders are from 0.5 to 15% by weight, preferably from 2 to 10% by weight, based on magnesium pyrophosphate.

In order to increase the stability of the suspension during the polymerization reaction, it can be necessary in particular prior to addition of the extender, as a function of the nature of the stirrer and reactor used, to increase the stirrer rotation rate. It is preferable that the average power input is above 0.2 W/kg of reactor contents.

If the average particle diameter of the prepolymer beads is too small, the amount of extender used can be reduced, or the stirrer rotation rate can be lowered after extender addition has taken place, in such a way that the value assumed by the average power input is below 0.2 W/kg.

A circumstance which has been found to be advantageous for the stability of the suspension is the presence, at the start of the suspension polymerization reaction, of a solution of polystyrene (or of an appropriate styrene copolymer) in styrene (or in the mixture of styrene with comonomers). It is preferable here to start from a solution of strength from 0.5 to 30% by weight, in particular from 3 to 20% by weight, of polystyrene in styrene. It is possible here to dissolve virgin polystyrene in monomers, but it is advantageous to use what are known as marginal fractions, these being excessively large or excessively small beads removed during the fractionation of the range of beads produced during the production of expandable polystyrene. Particular preference is given here to use of marginal fractions from step a) which had been removed in stage c).

It is preferable to use at least one high-temperature peroxide alongside the conventional peroxides in stage a). The expression high-temperature peroxide means a peroxide which has a half-life time of 1 hour in the range from 110 to 160° C. in cumene, preferably in the range from 120 to 140° C., particularly preferably in the range from 125 to 135° C. Examples of suitable peroxides are di-tert-amyl peroxide, tert-butyl peroxybenzoate, di(tert-butylperoxyisopropyl)benzene, 2,5-dimethyl-2,5-di(tert-butylperoxy)hexane, and dicumyl peroxide. It is particularly preferable to use dicumyl peroxide as high-temperature peroxide.

The total amounts used of the at least one high-temperature peroxide in stage a) are generally at least 0.5% by weight, preferably in the range from 1.1 to 5.0% by weight, particularly preferably in the range from 1.3 to 4% by weight, based on the prepolymer beads.

It is particularly preferable to use, in stage a), from 5 to 50% by weight of graphite and from 0.5 to 5% by weight of at least one high-temperature peroxide, in particular dicumyl peroxide, based in each case on the prepolymer beads, and it is particularly preferable to carry out the suspension polymerization reaction in stage a) for less than 1.5 h at a temperature in the range from 120 to 130° C. This method gives a prepolymer which comprises a sufficient amount of undecomposed dicumyl peroxide, and permits suspension polymerization in stage d) without addition of further peroxides. Furthermore, the material can also act as flame retardant synergist in the expandable styrene polymer. It is preferable that the amounts remaining of the high-temperature peroxide in undecomposed form in the prepolymer are from 50 to 100% by weight, particularly from 60 to 80% by weight, based on the amount used. This remaining high-temperature peroxide can act as sole polymerization initiator in the main polymerization reaction (stage d).

The invention therefore also provides prepolymer beads which comprise from 5 to 50% by weight, preferably from 10 to 30% by weight of graphite and from 0.5 to 5% by weight, preferably from 1 to 4% by weight, of dicumyl peroxide, based in each case on prepolymer.

### Stage b)

The prepolymer beads obtained are first isolated from the aqueous phase. The prepolymer beads are then used directly, or after division into fractions and selection of a particle-size fraction (stage c), in a main polymerization reaction (stage d).

### Stage c)

In the optional stage c), the prepolymer beads are divided into fractions of different particle size, and one or more fraction(s) is/are selected for subsequent stages. The fractionation process generally involves sieve-extraction of one or more sieve fractions. The bead size of the expandable styrene polymer can be controlled in targeted fashion by sieving the prepolymer beads in a suitably selected manner. It is preferable that, in stage c), a sieve fraction of the prepolymer beads with particle size in the range from 0.2 to 1.5 mm, particularly in the range from 0.3 to 1.3 mm, is extracted by sieving.

### Stage d)

At least one second suspension polymerization reaction is carried out in stage d). This means that the process can be carried out in two or more stages. By way of example, stages b) to d) can be carried out several times, where at least one suspension polymerization reaction is carried out in the presence of blowing agent and with addition of further styrene monomers. However, it is preferable that the process of the invention is carried out in two stages by executing stages a), b), c), and d) once.

In the at least second suspension polymerization reaction, the isolated in stage b) or the one or more fractions of the prepolymer beads selected in stage c) is used as initial charge in aqueous suspension.

In contrast to the suspension polymerization reaction in stage a), in which the entire amount of styrene monomer is generally used as initial charge, the styrene monomer in stage d) is preferably metered continuously into the mixture. From 10 to 60% by weight, preferably from 15 to 35% by weight, particularly preferably from 25 to 35% by weight, based in expandable styrene polymer, is generally used here as initial charge in the aqueous phase in the form of prepolymer beads, and the remainder is continuously metered in the form of monomers, particularly preferably in the form of styrene monomer, into the mixture. Prior to start of the polymerization reaction, the prepolymer beads can first be permitted to undergo incipient swelling with an organic peroxide, such as tert-butyl 2-ethylperoxyhexanoate, at a temperature below the polymerization temperature. It has moreover proven to be advantageous, likewise at a temperature below the polymerization temperature, to add a white oil or a portion of the styrene monomer to be added.

Stage d) can optionally use the particulate additives and additional substances described for stage a).

For stabilization of the second suspension polymerization reaction, a phosphate is likewise used, preferably magnesium pyrophosphate or tricalcium phosphate. Magnesium pyrophosphate is generally used as initial charge at the start of the polymerization reaction, and the concentration thereof in stage d) is generally from 0.03 to 2.0% by weight, preferably from 0.05 to 0.5% by weight, and particularly preferably from 0.1 to 0.2% by weight, based on the aqueous phase.

An extender is moreover likewise used as initial charge prior to the start of the polymerization reaction in stage d), in the aqueous phase. The amounts generally used of the extenders are from 0.5 to 15% by weight, preferably from 2 to 10% by weight, based on magnesium pyrophosphate.

Blowing agents used are usually aliphatic hydrocarbons having from 3 to 10, preferably from 4 to 6, carbon atoms, for example, n-pentane, isopentane, or a mixture thereof. The amounts added of the blowing agent are the usual amounts of from 1 to 10% by weight, preferably from 3 to 8% by weight, based on the weight of the styrene polymers present in the expandable styrene polymer.

The proportion used of the prepolymer in the aqueous phase is usually in the range from 10 to 60% by weight, preferably in the range from 20 to 40% by weight, based on expandable styrene polymer.

The addition of styrene monomer in stage d) generally takes place continuously, preferably over a period in the range from 1 to 5 hours. In a method which has proven advantageous here, from 5 to 15% by weight of the styrene monomer to be added are added to the reactor at temperatures below 100° C. before the heating phase has ended.

The polymerization reaction in stage d) preferably takes place at least to some extent at a temperature in the range from 115 to 130° C.

It is preferable that no peroxidic initiator is added in stage d). In particular, it is possible to omit use of a conventional low-temperature initiator, such as tert-butyl 2-ethylperoxyhexanoate, when, as described above, prepolymer comprises a high-temperature initiator, such as dicumyl peroxide. This has the advantage that the polymerization reaction in stage d) can be carried out at temperatures above 120° C., with resultant possible reduction of polymerization time. It is moreover easier to achieve homogeneous graphite distribution between the core and the peripheral regions of the bead polymer, since the diffusion of styrene into the center of the bead is much faster at temperatures above 120° C. Subsequent addition of dicumyl peroxide at the start of the main polymerization reaction is problematic because dicumyl peroxide is only incompletely absorbed by the prepolymer and under the typical conditions of polymerization decomposes to some extent to give cumyl hydroperoxide, which causes parallel emulsion polymerization in the aqueous phase. A consequence here is formation of very large amounts of white, graphite-free secondary polymer.

The expandable styrene polymer particles obtained by the process of the invention can be coated with the usual coating compositions, for example metal stearates, glycerol esters, and fine-particle silicates.

The diameter of the styrene polymer particles comprising blowing agent and produced in the invention is generally from 0.2 to 4 mm, preferably from 0.7 to 2.5 mm. They can be prefoamed by conventional methods, e.g. using steam, to give foam particles of diameter from 0.1 to 2 cm and of bulk density from 5 to 100 kg/m³.

The prefoamed particles can then be foamed to completion by the usual processes to give foam moldings of density from 5 to 100 kg/m³.

The expandable styrene polymers obtained by the processes of the invention can be processed to give polystyrene foams of densities from 5 to 35 g/l, preferably from 8 to 25 g/l, and in particular from 10 to 15 g/l. To this end, the expandable particles are prefoamed. This is mostly achieved via heating of the particles with steam in what are known as prefoamers.

The particles thus prefoamed are then fused to give moldings. To this end, the prefoamed particles are charged to molds which do not have a gastight seal, and are treated with steam. The moldings can be removed after cooling.

The foams produced from the expandable styrene polymers of the invention feature excellent thermal insulation. Said effect is particularly clearly apparent at low densities. The reduction of thermal conductivity is sufficiently great to give compliance of the materials with the requirements of thermal conductivity class 035 (in accordance with DIN 18164, Part 1, Table 4).

A feature of the suspension polymerization reaction embodiment of the process of the invention is markedly increased stability of the suspension without phase inversion. The improved stability of the suspension gives a reliable and more efficient process. Better control of bead size distribution is achieved by virtue of the smaller amount of stabilizer. The internal water content of the resultant expandable styrene polymers can be markedly reduced.

The process of the invention can increase the yield of the fractions with a desired and marketable bead size distribution in particular in graphite-containing expandable styrene polymers. If sieving of the prepolymer beads is omitted, it is nevertheless possible to achieve narrower particle size distributions, i.e. higher yield of useful fraction, when comparison is made with a traditional suspension polymerization reaction in the presence of graphite.

### EXAMPLES

Unless otherwise stated, the starting materials used for the examples were as follows:
Graphite: UF 99.5 graphite from Graphitwerke Kropfmühl KG
Demineralized water: demineralized water
HBCD hexabromocyclododecane
Br-SBC brominated styrene-butadiene diblock copolymer (M_{w} 560000, styrene block content 37%, 1,2-vinyl content 72%, TGA weight loss 5% at 238° C.), produced as in Example 8 of WO 2007/058736
Trigonox 21S tert-butyl 2-ethylperoxyhexanoate
Winog 70 mineral oil
PS 158K PS 158K polystyrene from Styrolution GmbH
K30 emulsifier mixture of linear alkylsulfonates (C₁₅H_{30.9}(SO₃Na)_{1.1}, HLB 11-12), 1% by weight strength aqueous solution

Bead size distribution was determined by means of sieve analysis (standard 1) and evaluated as grain size GS and relative content (R).

The β value is defined as follows and is based on the Rosin, Rammler, Sterling, Bennet distribution; β=arctan(1/n)*180°/π; where n=ln(ln(1/R))=n*ln(dₛᵢₑᵥₑ)−n*ln(d′); R=exp(−(dₛᵢₑᵥₑ/d′)ⁿ); dₛᵢₑᵥₑ: mesh width of respective sieve, d′: average particle diameter at 63% by weight of cumulative Rosin, Rammler, Sterling, Bennet particle size distribution.

### Production of Mg₂P₂O₇ Suspension:

The examples below used, as Pickering stabilizer, a freshly prepared, amorphous magnesium pyrophosphate precipitate (MPP suspension). The Mg₂P₂O₇ suspension was produced by dissolving in advance in each case, for each of the examples below, 931.8 g of sodium pyrophosphate (Na₄P₂O₇, from Giulini) in 32 kg of water at room temperature (25° C.). A solution of 1728 g of magnesium sulfate heptahydrate (Epsom salt, MgSO₄×7 H₂O) in 7.5 kg of demineralized water was added, with stirring, to this solution, and the mixture was then stirred for 5 minutes. This gave an aqueous suspension of magnesium pyrophosphate (MPP).

### Comparative Example 1

### By Analogy with Example 1 of U.S. Pat. No. 6,130,265

The organic phase was produced by dissolving 2.30 kg of PS 158 K polystyrene, 54 g of dicumyl peroxide (Perkadox BC-FF, from AkzoNobel), and 24.5 g of 75% strength dibenzoyl peroxide (Lucidol 75, AkzoNobel) in 15.3 kg of styrene, and suspending 176 g of graphite (UF99.5, from Kropfmühl AG) in the mixture.

20 l of demineralized water were used as initial charge in a pressure-tight 50 l stirred tank with blade stirrer, and 2.87 kg of the freshly prepared Mg₂P₂O₇ suspension described above were added, with stirring at 150 rpm. The stirred tank had a blade stirrer, which was operated at a constant stirrer rotation rate of 150 rpm during the entire experiment. For the stirrer used and the dimensions of the tank, this corresponds to average power input of 0.143 W/kg.

The suspension was heated to 80° C. within 1.2 hours and then to 134° C. within 4.5 hours. 140 minutes after the temperature had reached 80° C., 63.2 g of a 2% strength solution of E30 emulsifier (produced from E30-40 from Leuna Tenside GmbH, 40% by weight of a mixture of sodium C₁₂-C₁₇-alkylsulfonates in water) were metered into the mixture. After a further 30 minutes, 1.17 kg of Pentan S (Haltermann/Exxon) were metered into the mixture. Finally, polymerization was completed at a final temperature of 134° C.

The resultant expandable polystyrene beads were isolated by decanting, and dried to remove internal water, and coated with a mixture of glycerol monostearate, glycerol tristearate and precipitated silica. The dicumyl peroxide content of the EPS beads is 0.2% by weight, and their sieve distribution is as follows:

| GS [mm] | R [%] |
|---|---|
| 2.50 | 0.0 |
| 2.00 | 0.1 |
| 1.60 | 0.9 |
| 1.40 | 2.6 |
| 1.25 | 4.9 |
| 1.00 | 19.6 |
| 0.90 | 12.2 |
| 0.63 | 35.1 |
| 0.50 | 11.4 |
| 0.40 | 5.6 |
| 0.20 | 6.0 |
| <0.20 | 1.5 |

### Comparative Example 2

### By Analogy with Example 3 of U.S. Pat. No. 6,130,265

Comparative Example 1 was repeated, except that 636 g of graphite (4% by weight) were added to the organic phase.

| GS [mm] | R [%] |
|---|---|
| 3.15 | 0.7 |
| 2.50 | 0.4 |
| 2.00 | 0.8 |
| 1.60 | 2.3 |
| 1.25 | 8.3 |
| 1.00 | 16.6 |
| 0.80 | 22.5 |
| 0.63 | 20.7 |
| 0.50 | 11.0 |
| 0.40 | 5.5 |
| 0.20 | 7.3 |
| <0.20 | 4.0 |

### Inventive Example 1

### Stage a

### Production of Prepolymer Beads

The organic phase was produced by dissolving 2.80 kg of EPS from Comparative Example 2, 756 g of hexabromocyclododecane (Chemtura), 9.00 g of tert-butyl 2-ethylperoxyhexanoate (Trigonox 21S, AkzoNobel), 182 g of dicumyl peroxide (Perkadox BC-FF, AkzoNobel), 18.0 g of dicetyl peroxydicarbonate (Perkadox 24-FL, AkzoNobel) and 420 g of white oil (Winog 70) in 14.0 kg of styrene, and suspending 2.10 kg of graphite (UF99.5, Kropfmühl AG) in the mixture.

15 l of demineralized water was used as initial charge in a pressure-tight 50 l stirred tank with blade stirrer, and 5.22 kg of the freshly produced Mg₂P₂O₇ suspension described above was added, with stirring at 240 rpm. The stirred tank had a blade stirrer, which was operated at a constant stirrer rotation rate of 240 rpm during the entire experiment. For the stirrer used and the dimensions of the tank, this corresponds to average power input of 0.579 W/kg.

The suspension was heated to 95° C. within 1.5 hours and then to 127° C. within 4.2 hours. 100 minutes after the temperature had reached 80° C., 240 g of a 2% strength solution of E30 emulsifier (produced from E30-40 from Leuna Tenside GmbH, mixture of sodium C₁₂-C₁₇-alkylsulfonates) were metered into the mixture. Finally, polymerization was completed at a final temperature of 127° C.

The internal water content of the prepolymer was 5.23% and its average diameter was 0.8 mm.

### Stage b

The resultant prepolymer beads were filtered by way of a suction filter funnel (pore size 40 μm) and dried to remove surface water.

### Stage d

### Main Polymerization Reaction

600 g of demineralized water, 200 g of MPP suspension and 18.8 g of a 1% strength solution of E30 emulsifier (produced from E30-40, Leuna Tenside GmbH) were used as initial charge in a 2 l stirred tank, and 250 g of the prepolymer beads were then charged. 3.50 g of tert-butyl 2-ethylperoxyhexanoate (Trigonox 21S, AkzoNobel) were added dropwise to the suspension within 1 minute, with stirring. The tank was sealed, and 50 g of styrene were added to the tank over a period of 10 minutes. Once a temperature of 90° C. had been reached, a further 533 g of styrene were added within 95 minutes. The reaction mixture was then heated to 130° C. Starting at a temperature of 120° C., 67 g of Pentan S (Haltermann/Exxon) were added over a period of 40 minutes. Polymerization was continued for 2 hours at a temperature of 130° C. with stirring in order to achieve complete monomer conversion.

The resultant polystyrene beads comprising blowing agent were isolated by decanting, dried to remove internal water, and coated with a coating composition of glycerol monostearate, glycerol tristearate, and precipitated silica. The bead size distribution of the resultant EPS beads was as follows

| | | | |
|---|---|---|---|
| >2.5 | mm | 0.5 g | 0.07% |
| 1.4-2.5 | mm | 84.4 g | 11.20% |
| 0.8-1.4 | mm | 493.3 g | 65.46% |
| 0.4-0.8 | mm | 107.4 g | 14.25% |
| 0-0.4 | mm | 68 g | 9.02% |

### Inventive Example 2a

Inventive Example 1 was repeated, except that the prepolymer beads were then sieved through a sieve from Fritsch (Analysette 18). The subsequent main polymerization reaction used a sieve cut from 0.4 mm to 1.25 mm.

| | | |
|---|---|---|
| 2.00 mm | 0.23 g | 0.76% |
| 1.60 mm | 1.49 g | 4.90% |
| 1.25 mm | 13.29 g | 43.69% |
| 1.00 mm | 10.38 g | 34.12% |
| 0.80 mm | 2.46 g | 8.09% |
| 0.63 mm | 2.38 g | 7.82% |
| 0.50 mm | 0.17 g | 0.56% |
| 0.40 mm | 0.02 g | 0.07% |
| <0.40 mm | <0.02 g | <0.01% |

### Inventive Example 2b

Inventive Example 2a was repeated, except that in the main polymerization reaction, prior to start of the heating phase, 2.92 g of dicumyl peroxide dissolved in 5 g of styrene were added to the cold reactor within 2 minutes. The dried polymer gave the following sieve distribution:

| | | | |
|---|---|---|---|
| >2.5 | mm | 0.5 g | 0.06% |
| 1.4-2.5 | mm | 73.5 g | 9.34% |
| 0.8-1.4 | mm | 571.6 g | 72.65% |
| 0.4-0.8 | mm | 92.5 g | 11.76% |
| 0-0.4 | mm | 48.7 g | 6.19% of white graphite-free polymer |

### Inventive Example 3

Inventive Example 1 was repeated, except that the prepolymer beads were then sieved through a sieve from Fritsch (Analysette 18) (stage c). The subsequent main polymerization reaction used a sieve cut from 0.5 mm to 1.25 mm.

### Inventive Example 4

Inventive Example 2 was repeated, but 420 g of diisononyl 1,2-cyclohexanedicarboxylate (Hexamoll Dinch, BASF SE) were used instead of white oil. The internal water content of the prepolymer was 4.76%. The subsequent main polymerization reaction used a sieve cut from 0.4 mm to 1.25 mm.

### Inventive Example 5

Inventive Example 2 was repeated, but 420 g of alkylsulfonic ester of phenol (ASE) (Mesamoll 2, Lanxess AG) were used instead of white oil. The internal water content of the prepolymer was 3.16%. The subsequent main polymerization reaction used a sieve cut from 0.4 mm to 1.25 mm.

### Inventive Example 6

Inventive Example 2 was repeated, but 1.06 kg of brominated styrene-butadiene block copolymer (Br-SBS) were used instead of HBCD. The internal water content of the prepolymer was 2.56%. The subsequent main polymerization reaction used a sieve cut from 0.4 mm to 1.25 mm.

### Inventive Example 7

### Stage a

### Production of Prepolymer

The organic phase was produced by dissolving 2.80 kg of EPS from Comparative Example 2, 756 g of hexabromocyclododecane (Chemtura), 9.00 g of tert-butyl 2-ethylperoxyhexanoate (Trigonox 21s, AkzoNobel), 350 g of dicumyl peroxide (Perkadox BC-FF, AkzoNobel), 18.0 g of dicetyl peroxydicarbonate (Perkadox 24-FL, AkzoNobel) and 420 g of white oil (Winog 70) in 14.0 kg of styrene, and suspending 2.10 kg of graphite (UF99.5, Kropfmühl AG) in the mixture.

15 l of demineralized water was used as initial charge in a pressure-tight 50 l stirred tank with blade stirrer, and 5.22 kg of the freshly produced Mg₂P₂O₇ suspension described above was added, with stirring at 240 rpm. The stirred tank had a blade stirrer, which was operated at a constant stirrer rotation rate of 240 rpm during the entire experiment. For the stirrer used and the dimensions of the tank, this corresponds to average power input of 0.579 W/kg.

The suspension was heated to 95° C. within 1.5 hours and then to 125° C. within 4.2 hours. 100 minutes after the temperature had reached 80° C., 240 g of a 2% strength solution of E30 emulsifier (produced from E30-40 from Leuna Tenside GmbH, mixture of sodium C₁₂-C₁₇-alkylsulfonates) were metered into the mixture. Finally, polymerization was completed at a final temperature of 125° C.

### Stage b

The resultant prepolymer beads was isolated by decanting and dried to remove surface water, and sieved.

### Stage c

The subsequent main polymerization reaction used a sieve cut from 0.4 mm to 1.25 mm.

### Stage d

### Main Polymerization Reaction

596 g of demineralized water, 196 g of MPP suspension and 18.5 g of a 1% strength solution of E30 emulsifier (produced from E30-40, Leuna Tenside GmbH) were used as initial charge in a 2.4 l stirred tank (crossblade stirrer, 360 rpm), and 245 g of the sieved prepolymer beads were then charged. Nitrogen (0.5 bar) was introduced into the sealed tank, and 30 g of styrene were added to the tank at room temperature within 6 minutes. The reactor was heated to 125° C. within 61 minutes, and a further 557 g of styrene were added within 105 minutes. 65 g of Pentan S (Haltermann/Exxon) were then added over a period of 40 minutes. Polymerization was continued for a further 2 hours at a temperature of 130° C. with stirring in order to achieve complete monomer conversion, and the mixture was then cooled to room temperature.

The resultant polystyrene beads comprising blowing agent were isolated by decanting, dried to remove internal water, and coated with a coating composition of glycerol monostearate, glycerol tristearate, and precipitated silica. The bead size distribution of the resultant EPS beads was as follows.

| | |
|---|---|
| 2.00 mm | 0.85% |
| 1.60 mm | 0.95% |
| 1.40 mm | 1.4% |
| 1.25 mm | 15.96% |
| 1.00 mm | 40.33% |
| 0.80 mm | 33.72% |
| 0.63 mm | 5.44% |
| 0.50 mm | 0.8% |
| 0.40 mm | 0.14% |
| 0.20 mm | 0.01% |

Specimens are extracted during the experiment. The polymer beads obtained after removal of the aqueous phase were subjected to residual monomer determination by means of HPLC and molecular weight determination by means of GPC. Residual monomer content at the end of the polymerization reaction was 0.22% by weight. Weight-average molecular weight: M_{w} 247900, number-average molecular weight: Mₙ 77610, and polydispersity: D=3.19.

### Inventive Example 8

### Stage a

### Production of Prepolymer

The organic phase was produced by dissolving 52.3 kg EPS from Comparative Example 2, 18.8 kg of hexabromocyclododecane (Chemtura), 224 g of tert-butyl 2-ethylperoxyhexanoate (Trigonox 21s, AkzoNobel), 8.71 kg of dicumyl peroxide (Perkadox BC-FF, AkzoNobel), 437 g of dicetyl peroxydicarbonate (Perkadox 24-FL, AkzoNobel) and 10.4 kg of white oil (Winog 70) in 328.2 kg of styrene, and suspending 52.3 kg of graphite (UF99.5, Kropfmühl AG) in the mixture.

378.0 kg of demineralized water were used as initial charge in a 1 m³ pilot-plant tank with crossblade stirrer, 171, 1 kg of Mg₂P₂O₇ suspension freshly produced by analogy with the abovementioned specification, and 828 g of magnesium sulfate*heptahydrate (Epsom salt) were added to the initial charge, with stirring at 240 rpm, and the organic phase was metered from the batch tank into the mixture. The stirrer rotation rate was then set to 68 rpm (corresponding to average power input of 0.29 W/kg).

The suspension was heated to 95° C. within 1.5 hours and then to 125° C. within 4.2 hours. 89 minutes after the temperature had reached 80° C., 4.00 kg of a 2% strength solution of E30 emulsifier (produced from E30-40 from Leuna Tenside GmbH, mixture of sodium C₁₂-C₁₇-alkylsulfonates) were metered into the mixture. After the emulsifier had been added, stirrer rotation rate was lowered to 42 rpm (corresponding to average power input of 0.070 W/kg). Finally, polymerization was completed at a final temperature of 125° C.

### Stage b

The resultant prepolymer is isolated through a (Conturbex H 320) screen centrifuge from Siebtechnik (0.2 mm sieve fabric), equipped with 200 ppm of E30 emulsifier by way of a conveying screw to provide antistatic properties, and dried by way of a flash dryer (average temperature: 70° C.) to remove surface water. The internal water content of the resultant prepolymer was 7.56%, and its dicumyl peroxide content was 1.44% by weight.

### Stage c

### Sieving

The prepolymer beads were presieved: sieve cut from 0.4 mm to 1.25 mm.

### Stage d

### Main Polymerization Reaction

534 g of demineralized water, 178 g of MPP suspension, and 17.2 g of a 1% strength solution of E30 emulsifier (produced from E30-40, Leuna Tenside GmbH) were used as initial charge in a 2.4 stirred tank (crossblade stirrer, 360 rpm). 236.9 g of the sieved prepolymer beads were then charged. Nitrogen (0.5 bar) was introduced into the sealed tank, and 31.4 g of styrene were added to the tank at room temperature within 6 minutes. The contents of the reactor were heated to a temperature of 125° C. within 61 minutes, and then a further 522.6 g of styrene were added within 105 minutes. 63 g of Pentan S (Haltermann/Exxon) were then added over a period of 40 minutes. The mixture was kept at a temperature of 125° C. for a further 95 minutes, and the contents of the reactor were heated to 130° C. within 30 minutes, and polymerization was continued at 130° C. for a further 30 minutes.

The resultant polystyrene beads comprising blowing agent were isolated by decanting, dried to remove internal water, and coated with a coating composition of glycerol monostearate, glycerol tristearate, and precipitated silica. The bead size distribution collated in Table 3 of the resultant EPS beads was as follows.

Specimens are extracted during the experiment. The polymer beads obtained after removal of the aqueous phase were subjected to residual monomer determination by means of HPLC and molecular weight determination by means of GPC. Residual monomer content at the end of the polymerization reaction was 0.18% by weight. Weight-average molecular weight: M_{w} 251610, number-average molecular weight: Mₙ 84841, and polydispersity: D=2.97.

### Inventive Example 9

### Stage a

### Production of Prepolymer

The organic phase was produced by dissolving 420 g of prepolymer beads from Inventive Example 8, 219 g of hexabromocyclododecane (Chemtura), 1.80 g of tert-butyl 2-ethylperoxyhexanoate (Trigonox 21s, AkzoNobel), 108 g of dicumyl peroxide (Perkadox BC-FF, AkzoNobel), and 3.5 g of dicetyl peroxydicarbonate (Perkadox 24-FL, AkzoNobel) in 2.80 kg of styrene, and suspending 588 kg of graphite (UF99.5, Kropfmühl AG) in the mixture.

The organic phase was introduced into 3.04 l of demineralized water with 1.60 kg of MPP suspension and 7.90 g of magnesium sulfate heptahydrate (Epsom salt) (Kali and Salz) in a 101 stirred tank (blade stirrer, 300 rpm, corresponding to average power input of 0.584 W/kg). The suspension was heated to 95° C. within 1.5 hours and then to 125° C. within 4.2 hours. 85 minutes after the temperature had reached 80° C., 37 g of a 2% strength solution of E30 emulsifier (Leuna Tenside GmbH) were metered into the mixture. Finally, polymerization was completed at a final temperature of 125° C.

### Stage b

The resultant prepolymer beads were isolated by decanting and dried to remove surface water.

### Stage c

### Sieving

The prepolymer beads were presieved: sieve cut from 0.45 mm to 1.00 mm.

### Stage d

### Main Polymerization Reaction

534 g of demineralized water, 178 g of MPP suspension, and 17.2 g of a 1% strength solution of E30 emulsifier (produced from E30-40, Leuna Tenside GmbH) were used as initial charge in a 2.4 stirred tank (crossblade stirrer, 360 rpm). 181 g of the sieved prepolymer were then charged. Nitrogen (0.5 bar) was introduced into the sealed tank, and 27.3 g of styrene were added to the tank at room temperature within 6 minutes. The contents of the reactor were heated to a temperature of 125° C. within 61 minutes, and then a further 577 g of styrene were added within 105 minutes. 150 minutes after a temperature of 125° C. had been reached, 63 g of Pentan S (Haltermann/Exxon) were added over a period of 40 minutes. The polymerization reaction was terminated at a temperature of 130° C.

The resultant polystyrene beads comprising blowing agent were isolated by decanting, dried to remove internal water, and coated with a coating composition of glycerol monostearate, glycerol tristearate, and precipitated silica. The resultant EPS beads had the bead size distribution collated in Table 3.

Specimens are extracted during the experiment. The polymer beads obtained after removal of the aqueous phase were subjected to residual monomer determination by means of HPLC and molecular weight determination by means of GPC. Residual monomer content at the end of the polymerization reaction was 0.31% by weight. Weight-average molecular weight: M_{w} 202310, number-average molecular weight: Mₙ 70665 and polydispersity: D=2.86.

### Inventive Example 10

### Stage a

### Production of Prepolymer

The organic phase was produced by dissolving 2.1 kg of EPS (produced as in Comparative Example 2), 892 g of Br-SBC, 9.00 g of tert-butyl 2-ethylperoxyhexanoate (Trigonox 21s, AkzoNobel), 365 g of dicumyl peroxide (Perkadox BC-FF, AkzoNobel), 18.0 g of dicetyl peroxydicarbonate (Perkadox 24-FL, AkzoNobel), and 420 g of white oil (Winog 70) in 14.0 kg of styrene, and suspending 2.17 kg of graphite (UF99.5, Kropfmühl AG) in the mixture.

The organic phase was introduced into 15 l of demineralized water which comprised 5.22 kg of MPP suspension in a 50 l stirred tank (blade stirrer, 240 rpm, corresponding to average power input of 0.579 W/kg). The suspension was heated to 95° C. within 1.5 hours and then to 125° C. within 4.20 hours. 100 (+/−5 min) minutes after a temperature of 80° C. had been reached, 240 g of a 2% strength solution of E30 emulsifier (produced from E30-40 from Leuna Tenside GmbH) were metered into the mixture. Finally, polymerization was completed at a final temperature of 125° C.

### Stage b

The resultant prepolymer beads was isolated by decanting and dried by flash drying to remove surface water. The intrinsic viscosity IV of the prepolymer was 74.6, corresponding to weight-average molecular weight about 200000 g/mol. Residual water content was 1.48% by weight, and residual monomer content was 0.02% by weight. The EPS beads had the following bead distribution:

| GS [mm] | R [%] |
|---|---|
| 3.15 | 0.0 |
| 2.50 | 0.1 |
| 2.00 | 0.2 |
| 1.60 | 0.2 |
| 1.25 | 5.3 |
| 1.00 | 6.1 |
| 0.80 | 26.5 |
| 0.63 | 28.8 |
| 0.50 | 17.1 |
| 0.40 | 6.7 |
| 0.20 | 7.4 |
| <0.20 | 1.6 |
| d′ (calc.) = | 0.81 |
| β (calc.) = | 16.0 |

### Stage c

### Sieving

The prepolymer beads were presieved: sieve cut from 0.4 mm to 1.12 mm, and is then used in the main polymerization reaction.

### Stage d

### Main Polymerization Reaction

3.24 kg of demineralized water which comprised 1.08 kg of MPP suspension and 51 g of 2% strength solution of E30 emulsifier (produced from E30-40, Leuna Tenside GmbH) were used as initial charge in a 10 l stirred tank (crossblade stirrer, 170 rpm). 1.44 kg of the sieved prepolymer were then charged. Nitrogen (0.5 bar) was then introduced into the sealed tank, and 320 ml of styrene were added at room temperature within 10 minutes. The contents of the reactor were heated to a temperature of 125° C. within 137 minutes, and a further 3.39 l of styrene were then added within 87 minutes. 27 minutes after a temperature of 125° C. had been reached, 307 g of Pentan S (Haltermann/Exxon) were added over a period of 60 minutes. 110 minutes after a temperature of 125° C. had been reached, the temperature is increased to 135° C. within one hour, and polymerization is completed at this temperature (residual monomer content <1000 ppm).

The resultant polystyrene beads comprising blowing agent were isolated by decanting, dried to remove internal water, and coated with a coating composition of glycerol monostearate, glycerol tristearate, and precipitated silica. Weight-average molar mass was M_{w}: 338200 g/mol. The resultant EPS beads had the following bead size distribution.

| GS [mm] | R [%] |
|---|---|
| 3.15 | 0.0 |
| 2.50 | 0.0 |
| 2.00 | 0.0 |
| 1.60 | 1.8 |
| 1.25 | 31.0 |
| 1.00 | 37.1 |
| 0.90 | 11.4 |
| 0.63 | 17.7 |
| 0.50 | 0.9 |
| 0.40 | 0.0 |
| 0.20 | 0.0 |
| 0.00 | 0.0 |
| d′ (calc.) = | 1.23 |
| β (calc.) = | 10.7 |

TABLE 1
Sieve distribution of prepolymer beads

| Inventive | Internal water | | | |
|---|---|---|---|---|
| Example | content | <0.4 mm | 0.4-1.25 mm | >1.25 mm |
| 2a | 5.23% | 13.44% | 85.3% | 1.27% |
| 3 | | 22.8% | 75.9% | 1.3% |
| 4 | 4.76% | 9.04% | 89.72% | 1.24% |
| 5 | 3.16% | 8.66% | 89.85% | 1.51% |
| 6 | 2.56% | 9.61% | 89.56% | 0.83% |
| 7 | | 23.8% | 76.2% | 0% |
| 8 | | 9.3% | 80.8% | 9.9% |

TABLE 2
Sieve distribution of EPS beads

| | | Inventive | Inventive | Inventive | Inventive |
|---|---|---|---|---|---|
| Grain size | | Example 3 | Example 4 | Example 5 | Example 6 |
| >2.5 | mm | 0.01% | 0.06% | 0.07% | 4.07% |
| 1.4-2.5 | mm | 21.03% | 14.28% | 9.92% | 24.06% |
| 0.8-1.4 | mm | 78.37% | 71.67% | 77.13% | 61.56% |
| 0.4-0.8 | mm | 0.39% | 12.45% | 12.48% | 10.05% |
| 0-0.4 | mm | 0.20% | 1.54% | 0.4% | 0.26% |

TABLE 3
Sieve distribution of EPS beads

| | | Inventive | Inventive | Inventive |
|---|---|---|---|---|
| Grain size | | Example 7 | Example 8 | Example 9 |
| >2.5 | mm | | | 0.26% |
| 2.0-2.5 | mm | 0.85% | | 0.38% |
| 1.6-2.0 | mm | 0.95% | 0.29% | 2.60% |
| 1.4-1.6 | mm | 1.4% | 6.49% | 5.62% |
| 1.25-1.4 | mm | 15.96% | 16.84% | 10.52% |
| 1.0-1.25 | mm | 40.33% | 38.12% | 36.11% |
| 0.8-1 | mm | 33.72% | 24.93% | 30.82% |
| 0.63-0.8 | mm | 5.44% | 13.08% | 10.82% |
| 0.5-0.63 | mm | 0.8% | 0.85% | 1.79% |
| 0.4-0.5 | mm | 0.14% | 0.13% | 0.62% |
| 0.2-0.4 | mm | 0.01% | 0.12% | 0.28% |
| >0.2 | mm | | 0.09% | 0.16% |

| | | |
|---|---|---|
| d′ (calc.) | 1.15 mm | 1.146 mm |
| β (calc.) | 10.72 | 10.88 |

### Inventive Example 11

Table 4 shows the relationship between the average particle size of the prepolymer beads (×50, seed) and the yield of product, classified by grain size class after the main polymerization reaction has taken place. The β value is stated as a measure of the breadth of the distribution, since the prepolymer likewise exhibits a particle size distribution.

Each of batches 1-4 used the same graphite-containing prepolymer (β_{seed}=16.4°). In the case of batch 1, a sieve cut from 0.4 to 1.0 mm was isolated from the prepolymer for the main polymerization reaction. The resultant product distribution after the main polymerization reaction (feed of 70% by weight of styrene) in product classes EPS 1, EPS 2, and EPS 3 is 28% by weight of EPS 3, 63.2% by weight of EPS 2, and 8.3% by weight of EPS 1.

The sieving to isolate the prepolymer in batch 2 was slightly different (lower sieve limit at 0.5 mm), and as a result of this the yield of EPS 2 fraction can be raised by almost 10% after the main polymerization reaction. Reducing the amount of prepolymer used and increasing the amount of styrene feed in the main polymerization reaction amplifies the effect described immediately above and reduces the amount of EPS 3 by 20% by weight, and increases the amount of each of EPS 1 and EPS 2 by about 10% by weight (cf. Table 2, batch 3). At this point it should be again emphasized that the product distribution obtained after the main polymerization reaction in essence depends on the sieving of the prepolymer and not on the average particle size of the prepolymer (which by virtue of the prepolymerization reaction is subject to a certain standard deviation resulting from the process, cf. Table 4). The product distribution provided by batch 4 is therefore almost identical with that provided by batch 1.

The product obtained from the two-stage suspension polymerization reaction comprises polymer particles with diameter from 0.8 mm to 2.0 mm. All the product can therefore be used in the typical fields of application of EPS.

The process described is extremely cost-effective and, when compared with a traditional suspension polymerization reaction, produces less unsalable marginal fractions: the first step, the prepolymerization, produces from 15 to 20% by weight of marginal fractions, which are removed by sieving. However, the main polymerization reaction uses only 30% by weight of prepolymer beads, and this means that the amount of unsalable marginal fractions produced, based on the entire process, is only 6% by weight.

This may be compared with traditional suspension polymerization reaction in the presence of graphite without subsequent addition of styrene, where the amount of unsalable marginal fractions produced is at least 25% by weight (bead diameter <0.8 mm) [see Comparative Example 1].

TABLE 4
Properties of prepolymer beads and particle size distribution
of resultant expandable styrene polymer EPS

| | Batch | | | |
|---|---|---|---|---|
| | 1 | 2 | 3 | 4 |
| x_{50,seed} [mm] | 0.68 | 0.68 | 0.68 | 0.78 |
| Min. of sieve cut [mm] | 0.4 | 0.5 | 0.5 | 0.4 |
| Max. of sieve cut [mm] | 1.0 | 1.0 | 1.0 | 1.0 |
| Seed/styrene monomer [% by wt.] | 30/70 | 30/70 | 25/75 | 30/70 |
| EPS 3 (0.5-0.93 mm) [% by wt.] | 28.5 | 17.5 | 8.8 | 22.2 |
| EPS 2 (0.93-1.46 mm) [% by wt.] | 63.2 | 72.9 | 73.2 | 64.8 |
| EPS 1 (1.46-2.5 mm) [% by wt.] | 8.3 | 9.6 | 18.0 | 13.0 |

1.-14. (canceled)

15. A process for producing expandable styrene polymers, said process comprising the following stages:
a) producing prepolymer beads through a first suspension polymerization reaction using an aqueous suspension comprising styrene monomers and comprising particulate additives,
b) isolating the prepolymer beads,
c) optionally dividing the prepolymer beads into fractions of different particle size and selecting one or more fractions for subsequent stages,
d) producing an aqueous suspension of the prepolymer beads and carrying out at least one second suspension polymerization reaction in the presence of blowing agent and with addition of further monomers.

16. The process of claim 15, wherein said particulate additives used in stage a) comprise from 5 to 50% by weight, based on the prepolymer beads, of carbon particles with average particle size in the range from 1 to 50 μm.

17. The process of claim 15, wherein the particulate additives have been modified with from 0.01 to 1% by weight of silane.

18. The process of claim 15, wherein at least one high-temperature peroxide is used in stage a).

19. The process of claim 15, wherein said flame retardants used in stage a) or d) comprise brominated organic bromine compounds.

20. The process of claim 15, wherein amounts of from 0.3 to 5% by weight, based on water, of an alkaline earth metal phosphate or alkaline earth metal pyrophosphate are used to stabilize the aqueous suspension in stage a).

21. The process of claim 15, wherein a sieve fraction of the prepolymer beads with particle size in the range from 0.2 to 1.5 mm is extracted by sieving in stage c).

22. The process of claim 15, wherein the proportion of the prepolymer beads is in the range from 10 to 60% by weight, based on expandable styrene polymer used as initial charge in the aqueous phase in step d).

23. The process of claim 15, wherein the total proportion of all of the particulate additives is in the range from 10 to 40 percent by weight, based on the prepolymer beads.

24. The process of claim 15, wherein the addition of further monomer in stage d) takes place over a period in the range from 1 to 5 hours.

25. The process of claim 15, wherein the polymerization reaction in stage d) takes place at least to some extent at a temperature in the range from 110 to 140° C.

26. The process of claim 15, wherein no peroxidic initiator is added in stage d).

27. The process of claim 15, wherein from 5 to 50% by weight of graphite and from 0.5 to 5% by weight of at least one high-temperature peroxide, in each case based on prepolymer beads, are used in stage a), and the suspension polymerization reaction in stage a) is carried out for less than 1.5 h at a temperature in the range from 120 to 130° C.

28. The prepolymer bead material obtained in stage b) of the process of claim 27.
